(19) United States
(12) Patent Application Publication
(10) Pub. No.: US 2026/0140674 A1
(43) Pub. Date: May 21, 2026

(54) DISPLAY APPARATUS, IMAGE FORMING APPARATUS, INFORMATION PROCESSING APPARATUS, AND COMPUTER PROGRAM

(71) Applicant: CANON KABUSHIKI KAISHA, Tokyo (JP)

(72) Inventor: SUMITO TANAKA, Tokyo (JP)

(21) Appl. No.: 19/387,837

(22) Filed: Nov. 13, 2025

(30) Foreign Application Priority Data
Nov. 20, 2024 (JP) 2024-202382

(51) Int. Cl. G06F 3/12; G06K 15/00; H04N 1/00

(52) U.S. Cl. CPC G06F 3/121; G06F 3/1235; G06K 15/4075; H04N 1/00408; H04N 1/00413; H04N 1/00477

(57) ABSTRACT

An image forming apparatus includes a consumable part which is replaceable, and a display configured to display a screen for inputting a reason for replacing the consumable part. The display may display a lifetime of the consumable part and the number of remaining days until expiration of the lifetime. The display may further display a numerical value indicating a degree of use of the consumable part in relation to a lifetime of the consumable part. The display may further display the number of remaining days until expiration of the lifetime which depends on the degree of use of the consumable part.

### BACKGROUND

### Field of the Technology

The present disclosure relates to a display apparatus, an image forming apparatus for forming an image on a sheet, an information processing apparatus, and a computer program.

### Description of the Related Art

An image forming apparatus is used under various conditions. For example, an image forming apparatus is used under a changing environmental condition (including temperature and humidity). In addition, frequency of use differs from one image forming apparatus to another. Timing to replace a consumable part of an image forming apparatus is deduced through calculation of a lifetime of the consumable part by a provider of the apparatus in many cases. In some other cases, timing to replace a consumable part is determined by a user's degree of tolerance with respect to image quality. For example, a user who is tolerant of degradation of image quality may continue to use a consumable part past the lifetime thereof without replacing.

When a consumable part reaches expiration of its lifetime, the image forming apparatus displays a status of the consumable part in the form of, for example, a numerical value such as “100%” or “100” to notify the user that the consumable part has reached expiration of its lifetime. This numerical value means that the consumable part has been used to reach a state in which normal operation can no longer be guaranteed.

As an example of the consumable part, a toner container which contains a toner is described. A remaining toner amount in the toner container is calculated based on a toner amount in the toner container at that time and a dot count (a count of dots of each color used to print) at the time of printing. When the remaining toner amount in the toner container (the lifetime) becomes less than a predetermined threshold value to cause a state in which an image is printable but the image quality cannot be guaranteed, it is determined that the consumable part (toner container) has reached expiration of the lifetime. However, even after the toner container reaches expiration of its lifetime, the image forming apparatus is not in a state in which an image is unprintable. The image forming apparatus is kept used even after the consumable part reaches expiration of its lifetime, as long as the user has no complaints on the image quality of the printed image.

Meanwhile, even when a consumable part has not reached expiration of the part's lifetime, the image quality may gradually degrade. For example, there are a photosensitive member having a photosensitive layer that is obtained by polymerization or cross-linking of a compound having an unsaturated polymerizable functional group with a hole transporting compound, and then curing the resultant substance, and a photosensitive member with a surface layer configured from amorphous silicon. In a roller charging method, discharge involves contact with a surface of the photosensitive member, and a contaminant such as a nitrogen oxide (NO, NH₃NOₓ, or the like), a silicon oxide (SiOₓ), or a sulfur oxide (SOₓ) is accordingly generated on and adheres to the surface of the photosensitive member. Such contaminant changes a state of the surface of the photosensitive member, to thereby gradually degrade the image quality of the printed image.

The contaminant on a surface of a photosensitive member of the related art is removed by scraping with a cleaning member, and an adverse effect from the adhesion of the contaminant is accordingly small. However, in a case in which the surface of the photosensitive member is hard, the cleaning member may not succeed in shaving a surface material of the photosensitive member, with the result that the contaminant may build up. This causes, in a case in which the contaminant is a low-resistance substance, for example, a resistance value on the surface of the photosensitive member to drop, and resultant image smearing degrades the image quality. Thus, timing to replace a consumable part (photosensitive member) based on a gradually degrading image quality depends heavily on the degree of tolerance of the user on the image quality. It is accordingly difficult to uniformly determine the lifetime of such consumable part.

In Japanese Patent Application Laid-open No. 2001-209281, there is described an image forming apparatus that outputs, with a drop of a toner amount in a toner container to a prescribed amount or smaller as a trigger, cautionary text indicating that a toner has been spent, information about a use history and the like, and information on a collection destination. A user can obtain the information on the collection destination from the output information. People at the collection destination can obtain information required for recycling such as the use history and the like of the collected toner container. In Japanese Patent Application Laid-open No. 2021-9246, displaying a scheduled replacement date which is set in advance on an operation unit is described.

### SUMMARY

A display apparatus according to one embodiment of the present disclosure includes a display configured to display a screen for inputting a reason for replacing a consumable part of an image forming apparatus.

An image forming apparatus according to another embodiment of the present disclosure includes a consumable part which is replaceable, and a display configured to display a screen for inputting a reason for replacing the consumable part.

An information processing apparatus which is configured to communicate with an image forming apparatus according to further embodiment of the present disclosure includes a consumable part which is replaceable, the information processing apparatus including a display configured to display a screen for inputting a reason for replacing the consumable part.

In still another embodiment according to another embodiment of the present disclosure, a computer program for causing a display to display a screen for inputting a reason for replacing a consumable part of an image forming apparatus is provided.

Features of the present disclosure will become apparent from the following description of embodiments with reference to the attached drawings. The following description of embodiments is described by way of example.

### BRIEF DESCRIPTION OF THE DRAWINGS

FIG. 1 is a configuration diagram of an image forming apparatus.

FIG. 2 is a flow chart for illustrating lifetime-related information storing processing.

FIG. 3 is an exemplary diagram of a status check screen.

FIG. 4 is an exemplary diagram of a replacement reason input screen.

FIG. 5 is another exemplary diagram of the status check screen.

FIG. 6 is a flow chart for illustrating another version of the lifetime-related information storing processing.

FIG. 7 is an exemplary diagram of another replacement reason input screen.

### DESCRIPTION OF THE EMBODIMENTS

Now, referring to the accompanying drawings, description is given of at least one exemplary embodiment of the present disclosure. Components described in the at least one embodiment below are provided so as to represent forms as examples of the present disclosure, and the scope of the present disclosure is not limited only to those components.

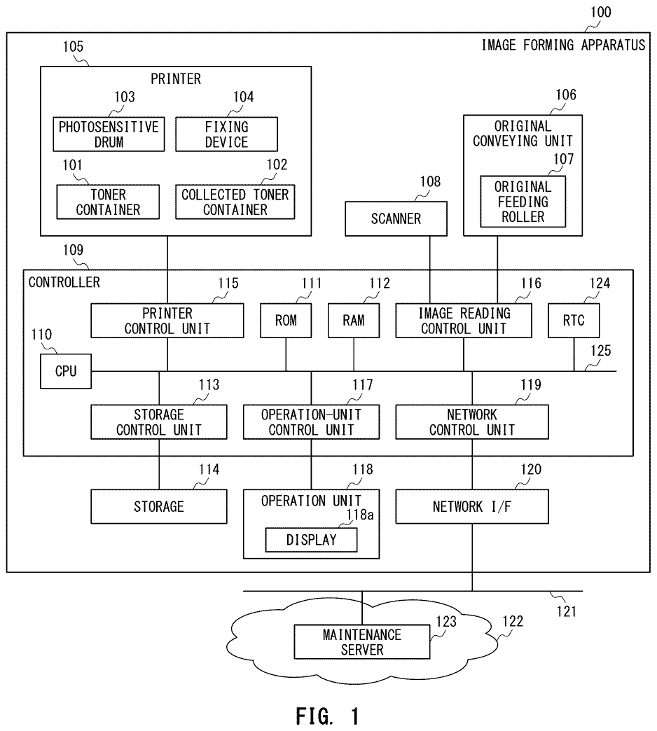

FIG. 1 is a configuration diagram of an image forming apparatus according to the at least one embodiment. An image forming apparatus 100 includes a printer 105, an original conveying unit 106, a scanner 108, a controller 109, a storage 114, an operation unit 118, and a network interface (I/F) 120. The image forming apparatus 100 includes a plurality of consumable parts which are replaceable by a user and a repair person. The consumable parts are parts for forming an image. Examples of the consumable parts include a toner container 101, a collected toner container 102, a photosensitive drum 103, and a fixing device 104 which are detachable from the printer 105.

The toner container 101 contains a toner used by the printer 105 to print. The collected toner container 102 contains a waste toner remaining on an image bearing member such as the photosensitive drum 103 after the printer 105 executes printing. A reduction in the toner contained in the toner container 101 (consumption of the toner) is hereinafter referred to as “wearing of the toner container 101.” With the reduction in the toner, a remaining lifetime of the toner container 101 shortens. An increase in amount of the waste toner contained in the collected toner container 102 is hereinafter referred to as “wearing of the collected toner container 102.”

The printer 105 in the at least one embodiment forms an image on a sheet by an electrophotographic method. To that end, the printer 105 forms a toner image on the photosensitive drum 103 based on bit map data generated by the controller 109, and transfers the toner image onto the sheet. The toner image transferred onto the sheet is fixed to the sheet by the fixing device 104. The photosensitive drum 103 is a photosensitive member having a photosensitive layer on its surface. The toner contained in the toner container 101 is supplied to a developing device (not shown) for forming a toner image on the photosensitive drum 103, and thus decreases. A toner remaining on the photosensitive drum 103 after the transfer of the toner image onto the sheet is collected in the collected toner container 102.

The printer 105 may employ an inkjet method in which an image is formed by ejecting ink which is a coloring material onto a sheet. In this case, an ink tank containing ink is provided as a consumable part instead of the toner container 101.

The original conveying unit 106 includes an original feeding roller 107. The original conveying unit 106 uses the original feeding roller 107 to convey an original placed on an original tray (not shown) to the scanner 108. The scanner 108 is an optical reading apparatus including a photoelectric conversion element such as a charge-coupled device (CCD). The scanner 108 scans the original conveyed from the original conveying unit 106 to generate image data representing an image of the original. The generated image data is stored in the storage 114 to be used in printing processing and the like.

The controller 109 is connected to the printer 105, the original conveying unit 106, the scanner 108, the storage 114, the operation unit 118, and the network I/F 120. The controller 109 is an information processing apparatus including a central processing unit (CPU) 110, a read-only memory (ROM) 111, and a random-access memory (RAM) 112. In addition thereto, the controller 109 includes a storage control unit 113, a printer control unit 115, an image reading control unit 116, an operation-unit control unit 117, a network control unit 119, and a real-time clock (RTC) 124. The CPU 110, the ROM 111, the RAM 112, the storage control unit 113, the printer control unit 115, the image reading control unit 116, the operation-unit control unit 117, the network control unit 119, and the RTC 124 are connected to one another via a bus 125 in a manner that enables communication to and from one another.

The controller 109 controls overall operation of the image forming apparatus 100 in an integrated manner. The CPU 110 boots an operating system (OS) by a boot program stored in the ROM 111. The CPU 110 also executes, on the OS, computer programs stored in the storage 114 and the ROM 111. The RAM 112 is a main memory of the CPU 110, and is also used as a temporary storage area such as a work area.

The storage control unit 113 accesses the storage 114 based on an instruction acquired from the CPU 110 to read and write data. The storage 114 is a non-volatile storage device which is readable and writable, such as a hard disk drive (HDD) or a solid-state drive (SSD). The storage 114 stores, for example, image data, a computer program for performing overall control of the image forming apparatus 100, and various application programs.

The storage 114 also stores lifetime-related information related to lifetimes of the consumable parts. The lifetime-related information includes information about the lifetimes of the consumable parts and information about the numbers of remaining days until expiration of the lifetimes of the consumable parts. The numbers of remaining days until expiration of the lifetimes of the consumable parts are the numbers of days for which the consumable parts are usable and which are calculated from the lifetimes of the consumable parts.

In the at least one embodiment, one CPU 110 uses one RAM 112 to execute processing procedures described later, but other modes may be employed. For example, the processing procedures described later may be executed by cooperation of a plurality of CPUs, RAMs, ROMs, and storages. Some of the processing procedures may be executed with use of a hardware circuit such as an application-specific integrated circuit (ASIC) or a field-programmable gate array (FPGA).

The printer control unit 115 controls operation of the printer 105 based on an instruction acquired from the CPU 110. The printer control unit 115 transmits bit map data, which is generated from image data, and a control signal to the printer 105 so that the printer 105 forms an image on a sheet.

The image reading control unit 116 controls operation of the original conveying unit 106 and the scanner 108 based on an instruction acquired from the CPU 110. The image reading control unit 116 uses the original feeding roller 107 provided in the original conveying unit 106 to convey one original at a time to the scanner 108. The image reading control unit 116 controls the scanner 108 to read an image of the original conveyed to the image reading control unit 116 by the original conveying unit 106, to generate image data.

The operation-unit control unit 117 controls the operation unit 118 based on an instruction acquired from the CPU 110. The operation unit 118 is a user interface including an input interface and an output interface. The input interface is a combination of various key buttons and a touch panel, or the like. The output interface is a combination of a display 118a and a speaker, or the like. The operation unit 118 in the at least one embodiment includes a touch panel display (the display 118a) which is a combination of the input interface and the output interface. The touch panel display (display 118a) functions as a display unit which displays information to a user and as a reception unit which receives instructions from the user. The CPU 110 acquires various instructions and settings from the input interface of the operation unit 118 via the operation-unit control unit 117. The CPU 110 displays various screens on the display 118a of the operation unit 118 via the operation-unit control unit 117.

The network control unit 119 controls operation of the network I/F 120. The network I/F 120 is connected to a communication line 121. The communication line 121 is at least one of a local area network (LAN), a wide area network (WAN), a public line, and the like. The network I/F 120 is a communication interface that controls, via the communication line 121, communication to and from a maintenance server 123 provided on a cloud 122. The image forming apparatus 100 can hold communication to and from the maintenance server 123 via the network I/F 120. For example, the image forming apparatus 100 transmits, via the network I/F 120, information about the consumable parts to the maintenance server 123. The maintenance server 123 is an information processing apparatus that collects and manages information for maintenance and inspection of the image forming apparatus 100. The maintenance server 123 in the at least one embodiment manages, for example, the lifetimes of the consumable parts of the image forming apparatus 100, and provides appropriate information to a repair person.

The RTC 124 is a clock built in the controller 109. The controller 109 uses the RTC 124 to, for example, calculate scheduled replacement dates for replacing the consumable parts.

Many consumable parts which are replaceable by a repair person, a user, a person in charge of maintenance, and the like are attached to the image forming apparatus 100. The term “user” hereinafter includes not only a user but also a repair person, a person in chart of maintenance, and the like.

The printer 105 includes, as described above, the photosensitive drum 103, the toner container 101, the fixing device 104, and the collected toner container 102 as consumable parts. Those consumable parts are configured so as to be detachable from the printer 105, and are subjects of maintenance by the user. For example, the toner container 101 requires to be replaced when a lifetime of a toner contained therein (a remaining toner amount) reaches a predetermined threshold value or lower. The collected toner container 102 requires to be replaced when an amount of a toner contained (collected) in the container reaches a predetermined threshold value or higher. The original feeding roller 107 and other components in the original conveying unit 106 are consumable parts that are subjects of maintenance. The original feeding roller 107 is configured so as to be detachable from the original conveying unit 106. The original feeding roller 107 requires to be replaced when, for example, a speed at which an original is conveyed reaches a predetermined speed or lower.

The controller 109 executes processing of deriving degrees of use of the consumable parts. For example, the degree of use of the toner container 101 is derived based on operation performance of the toner container 101, which is measured from the number of times the developing device has been refilled with the toner, lifetime detection (remaining toner amount detection) by a sensor, or the like. In the derivation, for example, a dot count obtained by counting the number of dots of an image to be printed may be added to factors for deriving the degree of use. The degrees of use of the collected toner container 102, the photosensitive drum 103, the fixing device 104, and the original feeding roller 107 are derived based on operation performance such as the number of sheets passed (the number of times of image forming operation), or a sheet travel distance.

The controller 109 calculates lifetimes of the consumable parts and the numbers of remaining days until expiration of the lifetimes based on the derived degrees of use, and stores the lifetimes and the numbers of remaining days as lifetime-related information in the RAM 112 and the storage 114. The lifetime-related information is updated each time the lifetimes and the numbers of remaining days are calculated anew. The lifetime-related information is stored in storage devices provided in the consumable parts as well. This enables the image forming apparatus 100 to read, for example, when a consumable part detached from the image forming apparatus 100 is reattached to the image forming apparatus 100, a lifetime of the consumable part and the number of remaining days until expiration of the lifetime, from the storage device of the consumable part.

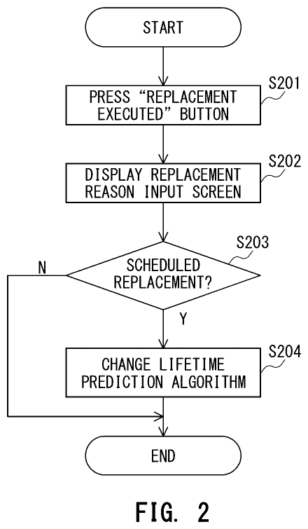

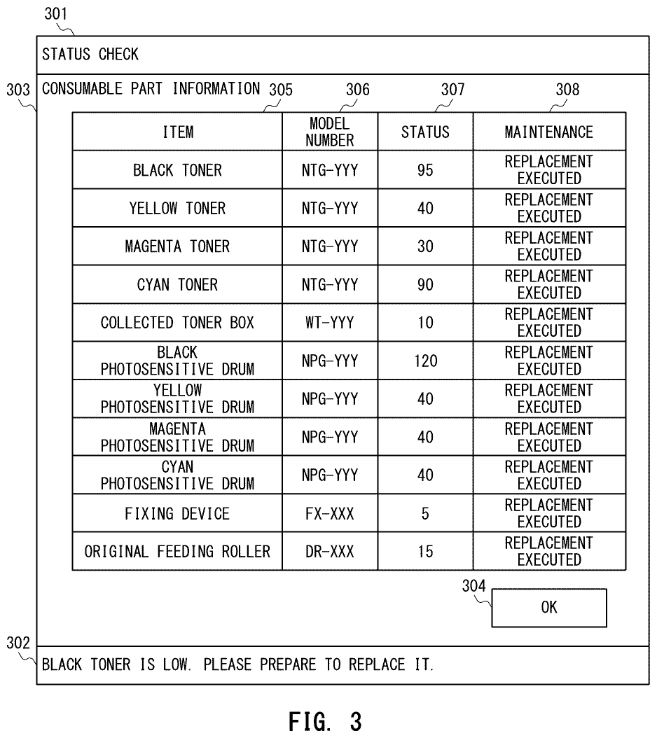

FIG. 2 is a flow chart for illustrating lifetime-related information storing processing executed by the image forming apparatus 100. The lifetime-related information includes information indicating whether a consumable part has been replaced, as scheduled, at timing deduced from the lifetime of the consumable part, or has been replaced unexpectedly regardless of the timing. In order to start this processing, the controller 109 displays a status check screen, an example of which is illustrated in FIG. 3, on the display 118a (display unit) of the operation unit 118. The status check screen is displayed by, for example, pressing a predetermined key button of the operation unit 118.

A status check screen 301 includes a status display area 302 and a main display area 303. In the status display area 302, a notification about a maintenance event that currently occurs in the image forming apparatus 100 is displayed. In FIG. 3, a message saying that “BLACK TONER IS LOW. PLEASE PREPARE TO REPLACE IT.” to prompt replacement of a consumable part is displayed. In a case in which a plurality of maintenance events currently occur, messages about the respective maintenance events are displayed in turn in the status display area 302.

An OK button 304 is displayed in the main display area 303. The OK button 304 is a button for closing the status check screen 301. When the user presses the OK button 304, displaying of the status check screen 301 is ended, and another screen is displayed on the operation unit 118. Columns for an item 305, a model number 306, a status 307, and maintenance 308 are displayed in the main display area 303. In the column for the item 305, part names of the consumable parts are displayed. In the column for the model number 306, model numbers of the consumable parts are displayed. In the column for the status 307, numerical values indicating the degrees of use in relation to the lifetimes of the consumable parts are displayed. For example, the degree of use that is “100” indicates that expiration of a lifetime of a consumable part has been reached. When the status 307 has a value equal to or more than “100,” this indicates operation of the consumable part is no longer guaranteed. A “replacement executed” button is displayed in the column for the maintenance 308.

The controller 109 causes a maintenance event to occur in response to a press, on the status check screen 301, of the “replacement executed” button displayed in the column for the maintenance 308 with respect to a part that is a subject of replacement (Step S201). The user presses the “replacement executed” button in a case in which the consumable part has been replaced in response to the message. The press of the “replacement executed” button enables the controller 109 to confirm that the user has replaced the consumable part (the part that is a subject of replacement).

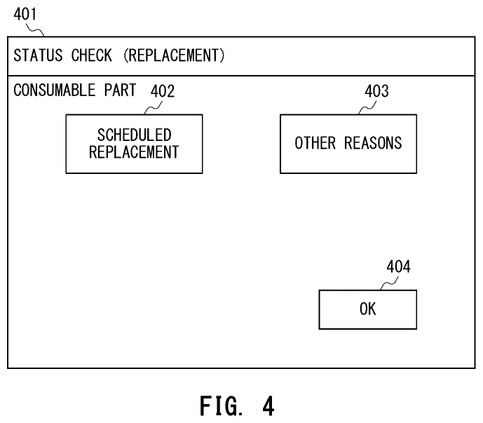

The controller 109 causes the maintenance event to occur, to thereby display, on the operation unit 118, a replacement reason input screen, an example of which is illustrated in FIG. 4 (Step S202). A replacement reason input screen 401 includes a selection screen including a “scheduled replacement” button 402 and an “other reasons” button 403. “Scheduled replacement” means replacement of a consumable part that is scheduled in advance so as to take place at timing deduced from the lifetime of the consumable part.

For maintenance and management of the image forming apparatus 100, a repair person regularly visits the image forming apparatus 100 that is a subject of management. A timetable for scheduled visits is created based on times at which parts are expected to reach expiration of the lifetimes (wearing times) of the parts. Replacement of the consumable parts is executed in accordance with the timetable. Replacing parts as scheduled minimizes the number of visits by a repair person and a lead time for shipping of a part. A case in which a consumable part has been replaced at timing based on the timetable in this manner corresponds to “scheduled replacement.”

The user operates the operation unit 118 to select one of the “scheduled replacement” button 402 and the “other reasons” button 403 on the selection screen of the replacement reason input screen 401 to press an OK button 404. The “scheduled replacement” button 402 is selected in a case in which replacement of a part is executed as scheduled. In scheduled replacement, a consumable part to be replaced is determined based on the number of remaining days until expiration of the lifetime of the consumable part which is prescribed in advance by a provider of the image forming apparatus 100. The “other reasons” button 403 is selected in a case in which a part is replaced at timing that is not on the schedule. For example, the “other reasons” button 403 is selected in a case in which a part has been replaced because an abnormal image (an image with streaks, or an image having an image density that is extremely low or extremely high) has suddenly been printed. A cause of an abnormal image is likely to be a failure of some consumable part.

The controller 109 determines whether or not the “scheduled replacement” button 402 has been selected (Step S203). When the “scheduled replacement” button 402 has been selected (Step S203: Y), the controller 109 changes a lifetime prediction algorithm and ends the processing (Step S204). When the “other reasons” button 403 has been selected (Step S203: N), the controller 109 ends the processing without changing the lifetime prediction algorithm. The lifetime prediction algorithm is an algorithm for calculating a lifetime of a consumable part and the number of remaining days until expiration of the lifetime, and is set for each consumable part separately.

A case in which the toner container 101 of a black toner as a consumable part is replaced as scheduled is described. In a case in which a consumable part is replaced at a time when the numerical value of the status 307 illustrated in FIG. 3 is “95,” the consumable part is replaced with the remaining lifetime thereof being “5.” In a case in which the input reason for the replacement taking place at a time when the numerical value of the status 307 is “95” is “scheduled replacement,” this indicates preference for the time when the numerical value of the status 307 is “95” over the time when the numerical value of the status 307 is “100” as timing to replace the consumable part. It is preferred for the status 307 to have, despite the fact that this consumable part has a remaining lifetime of “5” (that is, the status 307 is “95”), the numerical value “100”. Accordingly, in the at least one embodiment, the lifetime prediction algorithm of the consumable part is changed after the consumable part is replaced as scheduled. The changed lifetime prediction algorithm thus calculates the numerical value of the status 307 to be “100” under the same condition as a condition that has caused the lifetime prediction algorithm before the change to calculate the numerical value of the status 307 to be “95.”

The numerical value of the status 307 of the photosensitive drum for black exceeds “100” by “20” and is “120.” In a case in which the input reason for the replacement taking place at a time when the numerical value of the status 307 is “120” is “scheduled replacement,” this indicates preference for the time when the numerical value of the status 307 is “120” over the time when the numerical value of the status 307 is “100” as timing to replace the photosensitive drum for black. In the case of the photosensitive drum for black, the status 307 is preferred to have the numerical value “100” when a current use amount (the degree of wear) is larger than an amount of use that exceeds a lifetime determined in advance (that is, when the status 307 is “120”). Thus, in the case in which the numerical value of the status 307 is more than “100” as well, selection of the “scheduled replacement” button 402 means that the lifetime prediction algorithm used from then on is to be changed.

In the case in which the numerical value of the status 307 exceeds “100” by “20,” the change to take place is greater than expected by the provider of the image forming apparatus 100. Accordingly, after the “scheduled replacement” button 402 is pressed, the controller 109 may display a confirmation screen for checking whether the schedule is to be actually changed. Changing, when “scheduled replacement” is input as a reason for the replacement, the lifetime prediction algorithm so that the value of the status 307 becomes “100” at optimum timing for scheduled replacement enables lifetime prediction suited to the way of use of the user, and reduces early replacement and missed replacement.

That is, in scheduled replacement, a consumable part is replaced ideally when the status 307 is “100,” which corresponds to expiration of the lifetime of the consumable part. In practice, however, scheduled replacement is executed at timing offset by a predetermined number from the time when the numerical value of the status 307 is “100.” That is, the consumable part is replaced at timing different by a predetermined amount from replacement timing deduced from the lifetime of the consumable part. For that reason, in order to replace a consumable part at replacement timing deduced from the lifetime of the consumable part, the lifetime prediction algorithm is changed in accordance with the numerical value of the status 307 at the time when scheduled replacement is executed (an amount of offset from the lifetime).

In the case in which the “other reasons” button 403 is selected in the processing step of Step S203, the lifetime prediction algorithm is not changed because the replacement is executed for a reason other than scheduled replacement, as described above. A selection screen for selecting whether to change the lifetime prediction algorithm may be displayed on the operation unit 118 when the “other reasons” button 403 is selected, to allow the user to manually make a final decision. When an instruction to change the lifetime prediction algorithm is given on the selection screen, the controller 109 changes the lifetime calculation algorithm.

In the at least one embodiment, the lifetime prediction algorithm is expressed by a prediction expression. The prediction expression is designed by combining various parameters. In the case in which the “scheduled replacement” button 402 is selected, the prediction expression (lifetime prediction algorithm) is updated by changing the parameters. In the at least one embodiment, the prediction expression of the lifetime prediction algorithm is stored as a computer program in the ROM 111 or the storage 114.

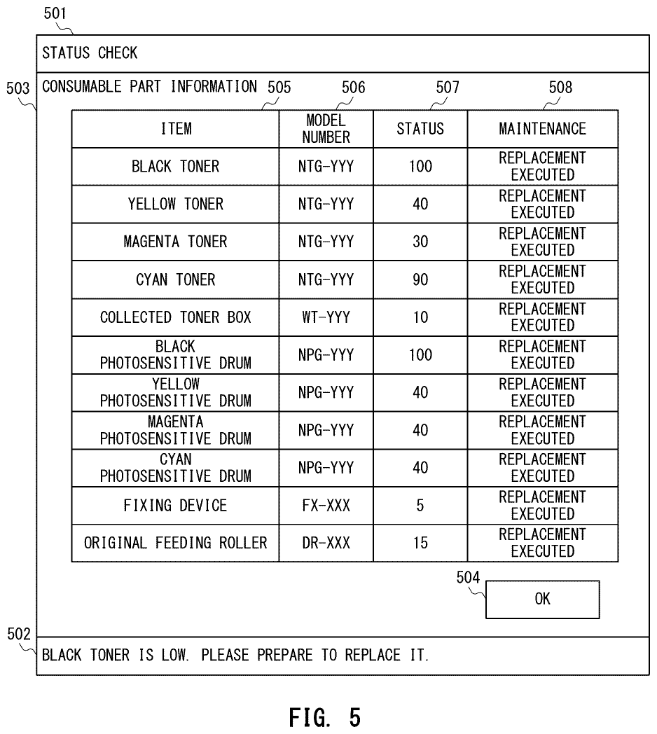

FIG. 5 is an exemplary diagram of the status check screen based on the lifetime-related information after replacement of a consumable part. A change from the status check screen of FIG. 3 is that numerical values of a status 507 are changed to “100” for the toner container 101 of the black toner and the photosensitive drum for black. The status 507 of the status check screen has the optimum value as a result of changing the lifetime prediction algorithm based on the timing of scheduled replacement. In this manner, when the replacement is recognized to be scheduled replacement and the “scheduled replacement” button 402 is pressed, the lifetime prediction algorithm is changed to display optimum replacement timing of the consumable part on the status check screen.

The lifetime-related information may be presented to the user on a screen other than the status check screen. For example, the lifetime-related information may be printed on a sheet to be presented to the user. The lifetime-related information may also be presented to a repair person by transmitting the lifetime-related information via electronic mail or the like to a terminal apparatus used by the repair person, or the maintenance server 123.

The image forming apparatus 100 may display the status check screen and the replacement reason input screen on the maintenance server 123 and the terminal apparatus used by the repair person in response to requests from those apparatus. In this case, the repair person and the person in charge of maintenance can remotely change the lifetime prediction algorithm via the maintenance server 123 or the like, without visiting a place in which the image forming apparatus 100 is installed. The repair person or the person in charge of maintenance may transfer the status from the maintenance server 123 to another apparatus to change the lifetime prediction algorithm.

The description given above uses the “toner container 101 of the black toner” and the “photosensitive drum for black” as an example of the consumable parts. The consumable parts are not limited thereto, and may include at least one of the toner container 101, the collected toner container 102, the photosensitive drum 103, the fixing device 104, and the original feeding roller 107.

Contents selected on the replacement reason input screen are accumulated as user data on the ROM 111 or the maintenance server 123. The user data is utilized in a service plan at a service base, or is utilized as market information in development design at a design site. According to the at least one embodiment described above, a numerical value set in advance can be changed to a numerical value suitable for scheduled replacement that accommodates various requests of the user to be displayed.

### Modification Example

The replacement reason input screen of FIG. 4 has two selectable buttons: the “scheduled replacement” button 402 and the “other reasons” button 403, but may be provided with more selectable buttons. Increasing the number of selectable buttons enables the user and the repair person to input a more detailed reason for the replacement of the consumable part.

There are typically following three reasons for replacement of the consumable parts of the image forming apparatus 100.
(1) Replace as scheduled (scheduled replacement)
(2) Determine on site to replace together with scheduled replacement of other parts (simultaneous replacement)
(3) Replace to deal with an abnormal image or occurrence of an error (unexpected replacement)

The simultaneous replacement is practiced often in order to reduce the number of visits by a repair person for the replacement purpose. In a case in which the length of travel time for visits is to be reduced, or a revisit in a short time is likely, a consumable part whose timing of scheduled replacement is not at that time is replaced simultaneously with a consumable part that is scheduled to be replaced at that time. In this case, the former consumable part is most times replaced earlier than the timing of the part's scheduled replacement.

The unexpected replacement is executed when a malfunctioning part causes an unexpected failure and is required to be replaced. The unexpected replacement is high in urgency in many cases, and leads to downtime.

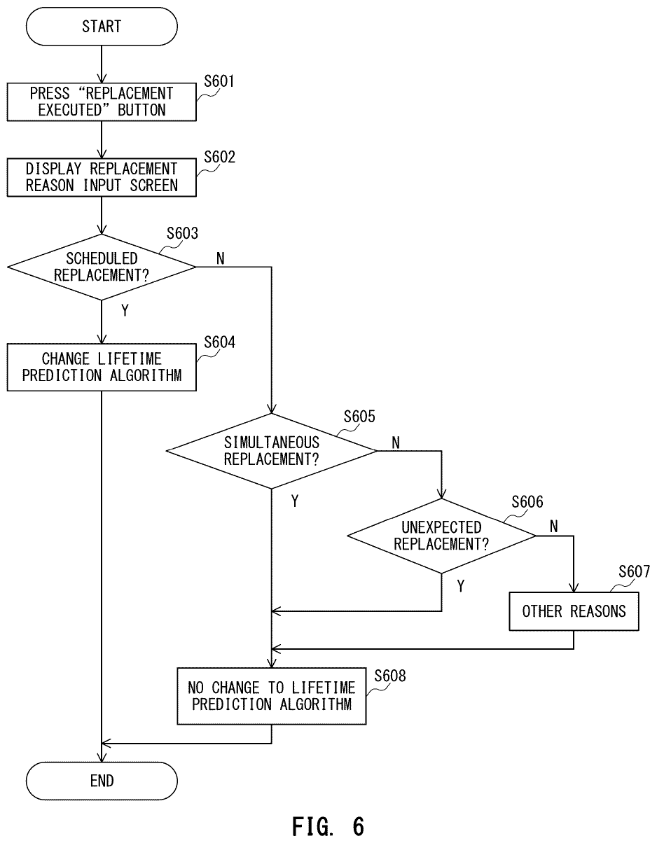

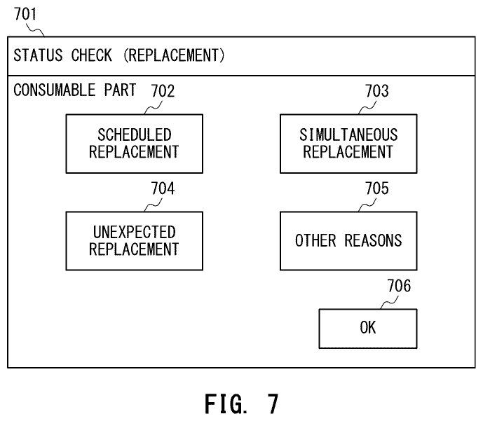

FIG. 6 is a flow chart for illustrating the lifetime-related information storing processing that is executed by the image forming apparatus 100 in this case. Processing steps of from Step S601 to Step S604 are the same as the processing steps of from Step S201 to Step S204 of FIG. 2. However, a replacement reason input screen displayed in Step S602 differs from that of FIG. 4. FIG. 7 is an exemplary diagram of the replacement reason input screen displayed in the processing step of Step S602 of FIG. 6.

In replacement other than the scheduled replacement, the lifetime prediction algorithm is not changed. This is because, in the simultaneous replacement, the consumable part is replaced earlier than the timing of the scheduled replacement of the consumable part in many cases. In a case in which the status 307 is to be set to “100” at that point, timing of the replacement of the next time and the subsequent times of the part becomes wrong. The lifetime prediction algorithm is not changed in the unexpected replacement as well. As described above, the unexpected replacement cannot be predicted and is accordingly not to be taken into account in lifetime calculation.

A selection screen of the replacement reason input screen, an example of which is illustrated in FIG. 7, includes a “scheduled replacement” button 702, a “simultaneous replacement” button 703, an “unexpected replacement” button 704, and an “other reasons” button 705. The “other reasons” button 705 is provided in anticipation for special reasons other than the above-mentioned three reasons.

When the “simultaneous replacement” button 703 is selected (Step S603: N, Step S605: Y), the controller 109 ends the processing without changing the lifetime prediction algorithm (Step S608). When the “unexpected replacement” button 704 is selected (Step S605: N, Step S606: Y), the controller 109 ends the processing without changing the lifetime prediction algorithm (Step S608). When the “other reasons” button 705 is selected (Step S606: N, Step S607), the controller 109 ends the processing without changing the lifetime prediction algorithm (Step S608).

When the “simultaneous replacement” button 703, the “unexpected replacement” button 704, or the “other reasons” button 705 is selected, the lifetime prediction algorithm is not changed because replacement is executed for a reason other than the scheduled replacement, as described above. A selection screen for selecting whether to change the lifetime prediction algorithm may be displayed on the operation unit 118 when the “simultaneous replacement” button 703, the “unexpected replacement” button 704, or the “other reasons” button 705 is selected, to allow the user to manually make a final decision. When an instruction to change the lifetime prediction algorithm is given on the selection screen, the controller 109 changes the lifetime calculation algorithm.

For each button on the selection screen of the replacement reason input screen, the number of times the button has been selected may be transmitted to the maintenance server 123. This enables the maintenance server 123 to grasp a utilization situation of the image forming apparatus 100 based on the numbers of times the respective buttons have been selected.

As described above, the image forming apparatus 100 according to the at least one embodiment changes the lifetime prediction algorithm when a reason for the replacement which is input by the user is the scheduled replacement. The displayed lifetime status can be optimized to suit the degree of tolerance of the user on image quality and timing of scheduled replacement that is determined at each service base. Accordingly, optimum timing for replacing a consumable part is set for each user separately and, as a result, a burden on a repair person is reduced.

Description has been given above of the case in which, after replacing a consumable part in response to the message of the status check screen 301, the user inputs a reason for the replacement on the replacement reason input screen 401 or 701. This order may be reversed. That is, the user may replace a consumable part after inputting a reason for the replacement on the replacement reason input screen 401 or 701.

The present disclosure is implementable also when a program for implementing one or more of functions of the at least one embodiment described above is supplied to a system or an apparatus via a network or a storage medium, and one or more processors in a computer of the system or of the apparatus read out the program and execute processing. For example, the maintenance server 123 may execute the processing illustrated in FIG. 2 or FIG. 6. The present disclosure is also implementable by a circuit (for example, an ASIC) that implements one or more of the functions.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-202382, filed Nov. 20, 2024, which is hereby incorporated by reference herein in its entirety.

What is claimed is:

1. A display apparatus comprising a display configured to display a screen for inputting a reason for replacing a consumable part of an image forming apparatus.

2. An image forming apparatus comprising:
a consumable part which is replaceable; and
a display configured to display a screen for inputting a reason for replacing the consumable part.

3. The image forming apparatus according to claim 2, wherein the display is configured to display a lifetime of the consumable part and the number of remaining days until expiration of the lifetime.

4. The image forming apparatus according to claim 2, wherein the display is configured to display a numerical value indicating a degree of use of the consumable part in relation to a lifetime of the consumable part.

5. The image forming apparatus according to claim 4, wherein the display is configured to display the number of remaining days until expiration of the lifetime which depends on the degree of use of the consumable part.

6. The image forming apparatus according to claim 2, wherein the display is configured to display a screen for selecting whether replacement of the consumable part has been executed.

7. The image forming apparatus according to claim 6,
wherein the display is configured to display a first button indicating that the replacement of the consumable part has been executed for a reason that the replacement is scheduled replacement, and a second button indicating that the replacement has been executed for a reason other than the scheduled replacement, and
wherein, when the first button is selected, a lifetime calculation algorithm is changed.

8. The image forming apparatus according to claim 7, further comprising at least one processor configured to change, when the first button is selected, the lifetime calculation algorithm for calculating a lifetime of the consumable part.

9. The image forming apparatus according to claim 8, wherein the display is configured to display, when the second button is selected, a selection screen for selecting whether to change the lifetime calculation algorithm.

10. The image forming apparatus according to claim 6, wherein the display is configured to display:
a first button indicating that the replacement of the consumable part has been executed at timing deduced from a lifetime of the consumable part;
a second button indicating that the replacement has been executed for a reason other than arrival of the deduced timing;
a third button indicating that the replacement has been executed at the same time as replacement of another part; and
a fourth button indicating that the replacement has been executed in order to deal with occurrence of an error.

11. The image forming apparatus according to claim 10, further comprising at least one processor configured to change, when the first button is selected, a lifetime calculation algorithm for calculating the lifetime.

12. The image forming apparatus according to claim 11, wherein the display is configured to display, when one of the second button, the third button, and the fourth button is selected, a selection screen for selecting whether to change the lifetime calculation algorithm.

13. The image forming apparatus according to claim 2, wherein the display is configured to display a message prompting replacement of the consumable part.

14. An information processing apparatus which is configured to communicate with an image forming apparatus including a consumable part which is replaceable,
the information processing apparatus comprising a display configured to display a screen for inputting a reason for replacing the consumable part.

15. A computer program for causing a display to display a screen for inputting a reason for replacing a consumable part of an image forming apparatus.
